(19) United States
(12) Patent Application Publication
(10) Pub. No.: US 2002/0056044 A1
(43) Pub. Date: May 9, 2002

(54) Security system

(76) Inventor: Stefan Andersson, Klagerup (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/977,192

(22) Filed: Oct. 16, 2001

Related U.S. Application Data
(60) Provisional application No. 60/242,451, filed on Oct. 24, 2000.

(30) Foreign Application Priority Data
Oct. 17, 2000 (GB) 0025435.9

(51) Int. Cl. H04L 9/00

(52) U.S. Cl. 713/189; 380/277

(57) ABSTRACT

A communications device, which has a cryptographic module for use in mobile communications, can be used as a cryptographic services provider. For example, the device may be a device which can operate under the Wireless Application Protocol, that is, a WAP-enabled device, such as a mobile phone. This has the advantage that WAP-enabled devices include components which are used in public key/private key cryptographic systems as a part of their standard communication functions. These components therefore advantageously allow the device to be used as a cryptographic services provider. Advantageously, the device can use Wireless Transport Layer Security (WTLS) for mobile communications, and employs its cryptographic module when in use as a cryptographic services provider.

### TECHNICAL FIELD OF THE INVENTION

This invention relates to computer systems, and in particular to the improvement of security in such systems. More specifically, the invention relates to a method for improving the security of communications, for example over a computer network, although it is also applicable to increasing the security of a computer system.

### BACKGROUND OF THE INVENTION

U.S. Pat. No. 5,689,565 describes a cryptography system architecture for a computer, which provides cryptographic functionality to support an application which requires cryptography. The cryptography system has a cryptographic application program interface (CAPI) which interfaces with the application to receive requests for cryptographic functions. The system further includes at least one cryptographic service provider (CSP) that is independent from, but dynamically accessible by, the CAPI. The CSP provides the cryptographic functionality and manages the secret cryptographic keys.

This system architecture is used in many applications in which data may desirably be transferred across unsecured computer networks such as the internet. For example, this architecture can be used in applications such as email clients, web browsers, etc. A similar architecture can be used for access control within a computer system, and for hard disc encryption.

U.S. Pat. No. 6,038,551 describes a development of the architecture disclosed in U.S. Pat. No. 5,689,565, in which the computer includes a card reader, and an integrated circuit card (IC card) stores the cryptographic keys used by the CSP in the computer, and can perform cryptographic functions in support of the CSP.

However, this system requires a user to have an IC card reader, while there is also a cost associated with the distribution of the IC cards themselves.

### SUMMARY OF THE INVENTION

According to a first aspect of the present invention, a mobile communications device, having a cryptographic module, is used as a cryptographic service provider.

This has the advantage that the existing cryptographic module within the mobile communications device can be reused, thus avoiding the need to distribute additional devices.

Preferably, the mobile communications device is a WAP-enabled device, and the cryptographic module of the device is that used in WTLS.

In a preferred embodiment of the invention, a communications device which has a cryptographic module for use in mobile communications, can be used as a cryptographic services provider. For example, the device may be a device which can operate under the Wireless Application Protocol, that is, a WAP-enabled device, such as a mobile phone. This has the advantage that WAP-enabled devices include components which are used in cryptographic systems, for example public key/private key cryptographic systems, as a part of their standard communication functions. These components therefore advantageously allow the device to be used as a cryptographic services provider. Advantageously, the device can use Wireless Transport Layer Security (WTLS) for mobile communications, and employs its cryptographic module when in use as a cryptographic services provider.

It should be emphasised that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

FIG. 1 is a block schematic diagram of a first system implementing the present invention.

FIG. 2 is a flow chart showing the operation of the system of FIG. 1.

FIG. 3 is a flow chart showing in more detail a part of the operation illustrated in FIG. 2.

FIG. 4 is a block schematic diagram of a second system implementing the present invention.

FIG. 5 is a block schematic diagram of a third system implementing the present invention.

FIG. 6 is a flow chart showing the operation of the system of FIG. 5.

### DETAILED DESCRIPTION OF PREFERRED EMBODIMENTS

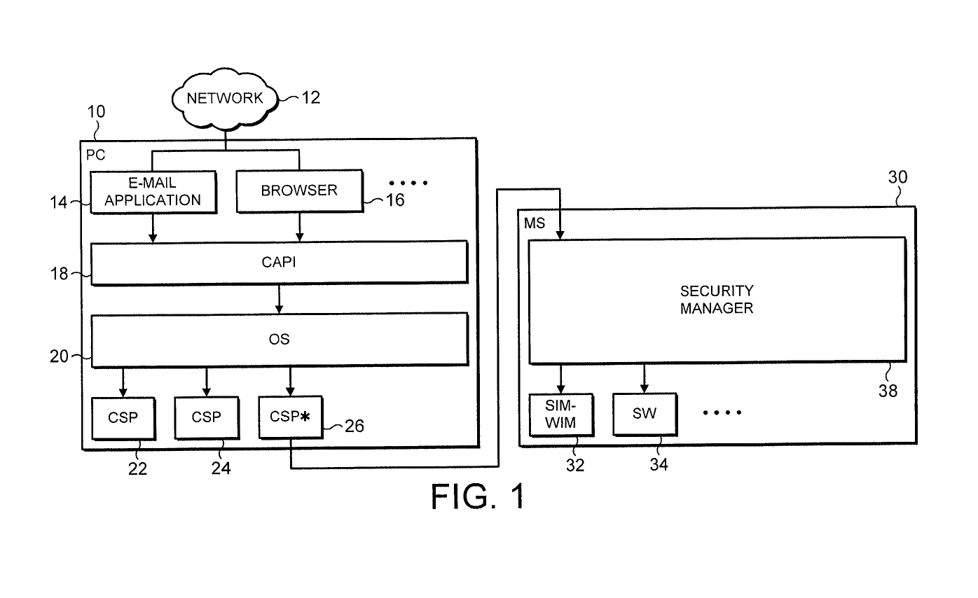

FIG. 1 is a block schematic diagram of a computer system, including a personal computer (PC) 10, only the relevant components of which are shown. It will be apparent that, in this embodiment of the invention, and in the other illustrated embodiments, any computer system can be used in exactly the same way as the PC 10.

The computer has a connection to an external network 12, for example through a modem (not shown). Of particular concern here is the situation where the computer 10 is connected to an unsecured network, such as the internet.

The computer 10 has various software applications which require external communication, such as an email application 14, and a web browser 16, which use Secure Socket Layer (SSL) and/or Transport Layer Security (TLS) security. In many cases, the information which is required to be sent by these applications is confidential, for example because it is personal, or could be used for criminal purposes. For example, when a user wishes to perform an online transaction, he generally needs to transmit financial information across the internet to the web site of a third party. It is therefore preferable if such transmissions can be encrypted.

As is conventional, therefore, applications such as the email application 14 and web browser 16 can call a cryptographic application program interface (CAPI) 18, which is provided on top of the operating system (OS) 20.

As is also conventional, the cryptographic application program interface (CAPI) 18 can access one or more cryptography service providers (CSPs) 22, 24.

Different cryptography service providers (CSPs) may, for example, use different cryptographic algorithms, and may be used for different purposes.

In accordance with the present invention, some or all of the functionality of a cryptography service provider is available on a separate device, namely a mobile station (MS) 30, as described in more detail below.

The mobile station may be any communications device with a suitable cryptographic module, for example a mobile phone, a personal digital assistant (PDA) or a communicator.

In this preferred embodiment, the mobile station 30 is a WAP-enabled device, for example, a mobile phone. The mobile phone 30 communicates over a wireless interface with a network, through a WAP Gateway.

In order to provide security between the WAP-enabled client device 30 and the WAP Gateway, Wireless Transport Layer Security (WTLS) can be used. This provides confidentiality for users, by encrypting messages which are transmitted over the wireless interface, and also provides authentication, by means of digital certificates.

In order to provide this WTLS functionality, the WAP-enabled device 30 includes a cryptographic module, which uses an embedded public key and private key on handshake for authentication, then generates symmetric session keys, which are used to encode messages before transmission and to decode received messages.

For example, the phone 30 may also include a Subscriber Identity Module—Wireless Identity Module (SIM-WIM) card 32, which is used to identify the subscriber, and can contain the cryptographic module. Alternatively, the cryptographic module can be realised in hardware or in software 34 in the phone 30, or may be provided on an external smart card. In order to access the cryptographic module, the MS 30 includes a security manager module 38. The operation of these devices will be explained further below.

In accordance with preferred embodiments of the present invention, the cryptographic module of the phone, and other features which are used to provide secure communication using the Wireless Application Protocol, also allow the phone 30 to be provide some or all of the functionality of a cryptography service provider.

In the case where the cryptographic module is embodied in hardware, the necessary information is provided on an integrated circuit in the device.

Where the Wireless Public Key Infrastructure (WPKI) is used to distribute the parameters for WTLS, it can also be used to distribute the parameters required for use as a cryptography service provider.

In order to allow the PC 10 to use the mobile phone 30 as a CSP, there must obviously be a communication link between them. The connection may be wired, or wireless. Advantageously, communications between the personal computer 10 and mobile phone 30 can take place using the Bluetooth short-range radio transmission protocol, although an infrared connection is also possible. The protocol for the connection can for example be based on AT commands, and provides security for those communications. The command set is advantageously a version of the command set defined in a standard such as PKCS#11, described in the document “PKCS#11 v2.10: Cryptographic Token Interface Standard”, published by RSA Security Inc. and incorporated herein by reference, where the commands are redefined as AT commands.

The PC therefore includes a modified cryptography service provider (CSP*) 26 which enables some or all of the required cryptographic functionality to be provided in the mobile phone 30. For example, the SIM-WIM card may contain the algorithm required to perform the well-known RSA encryption, but may not have sufficient memory or processing capability to calculate a message hash using the SHA-1 algorithm. In that case, the SHA-1 algorithm functionality can be provided on the modified cryptography service provider (CSP*) 26, while the RSA algorithm functionality can be provided on the MS 30.

The structure and function of the SIM-WIM card can be as defined in the document Wireless Application Protocol Identity Module Specification WAP-198-WIM, published Feb. 18, 2000, which is incorporated by reference herein.

It will be appreciated that many other divisions of the functionality between the cryptography service provider and the MS are possible.

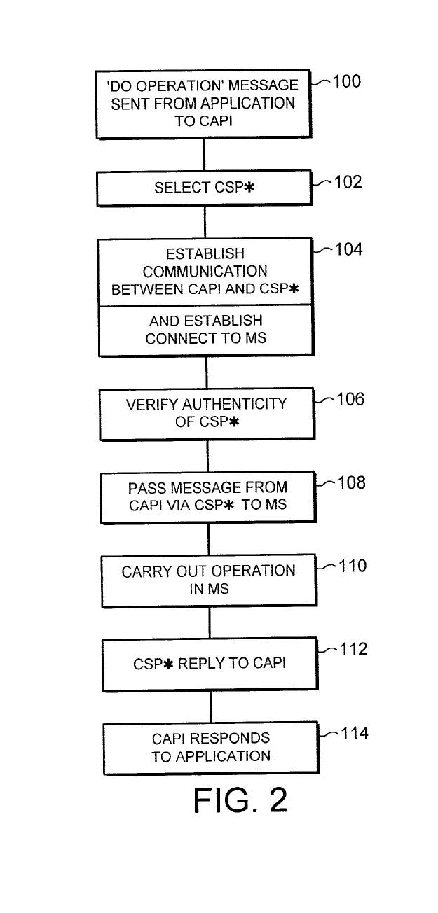

FIG. 2 is a flow chart showing a method by which the PC 10 can use the cryptographic functionality in the mobile phone 30.

The procedure starts with step 100, in which the application in the PC 10, such as the email application 14 or web browser 16 determines that cryptographic functionality is required, and sends a command to the CAPI 18. The cryptographic functionality which is required may for example be encryption, decryption, hash generation, message signing, verification, key generation, certificate management, or random number generation. Other types of cryptographic functionality which may be provided are described in the PKCS#11 standard mentioned above.

In step 102, the CAPI selects an appropriate CSP to provide the cryptography function. In this case, the CAPI selects the CSP* 26, which can access the cryptographic module in the MS 30.

In step 104, the CAPI 18 establishes communication with the selected CSP* 26, and the CSP* 26 establishes communications with the MS 30. As discussed above, the communications between the PC 10 and MS 30 can advantageously be over a Bluetooth short range radio link.

In step 106, the operating system (OS) 20 verifies the authenticity of the CSP*. It will be noted that this step may be unnecessary if the authenticity of the CSP* has already been established as part of an earlier process. As an alternative, this step can be carried out earlier in the process, and other changes in the order of the illustrated steps are also possible.

In step 108, a message is passed from the CAPI 18 via the CSP* 26 to the MS 30, with details of the cryptographic operation which is required.

In step 110, the required operation is carried out in the MS 30, as will be described in more detail below.

In step 112, the result of the operation in the MS 30 is sent to the CSP* 26, and then to the CAPI 18. In step 114, the CAPI 114 then responds to the application which requested the cryptographic functionality.

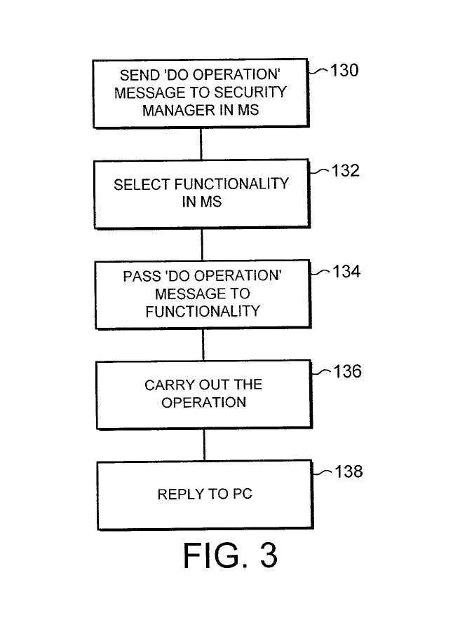

FIG. 3 shows the operation carried out in the MS 30, as described briefly as step 110 in FIG. 2 above.

In step 130, a message is received by the security manager 38, instructing the MS 30 to carry out the required cryptographic operation.

In step 132, the security manager 38 selects the appropriate functionality in the MS 30, depending on the cryptographic operation which is required.

In step 134, the security manager 38 passes the message, specifying the selected cryptographic function, to the cryptographic module, which carries out the operation in step 136.

Then, in step 138, the result of the cryptographic operation is sent back to the PC over the previously established communication link.

Thus, communications from the PC applications such as the email application 14 and web browser 16 can be encrypted using the same cryptographic functionality as WTLS, without requiring the distribution of additional keys, since the method reuses the functionality of the WAP-enabled device.

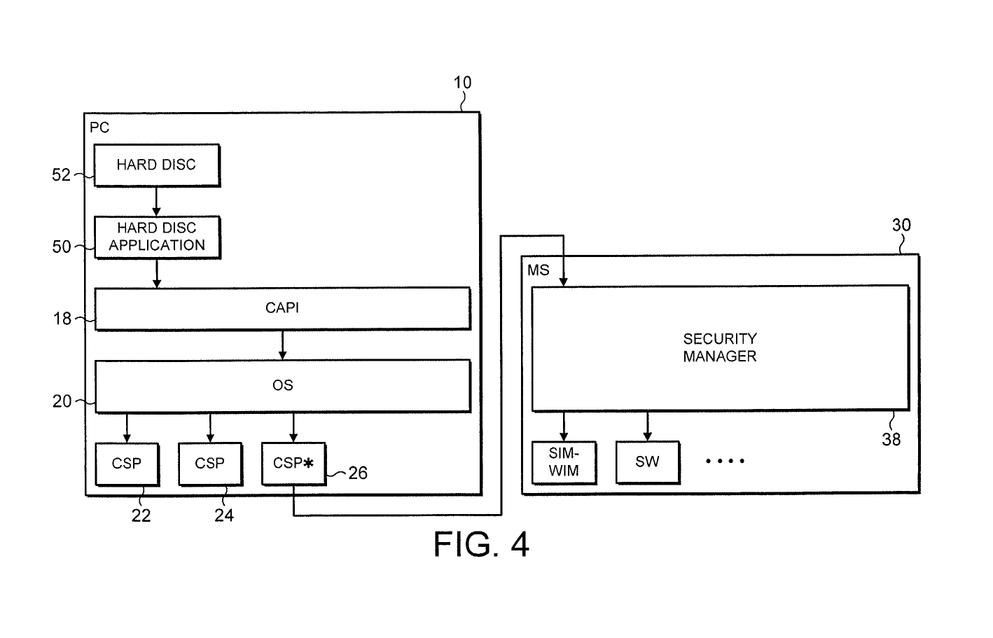

FIG. 4 is a block schematic diagram of a second computer system in accordance with the invention. In this case, the system includes a personal computer (PC) 10.

The computer has a hard disc 52, and FIG. 4 shows a representative software application 50 (including the hard disc drivers) which requires communication with the hard disc 52. Since the information which is stored on the hard disc may be confidential, the application restricts access thereto, so that only authorised persons can gain access to it.

As is conventional, therefore, the hard disc application 50 can call a cryptographic application program interface (CAPI) 18, which is provided on top of the operating system (OS) 20.

As is also conventional, the cryptographic application program interface (CAPI) 18 can access one or more cryptography service providers (CSPs) 22, 24.

Different cryptography service providers (CSPs) may, for example, use different cryptographic algorithms, and may be used for different purposes.

In accordance with the present invention, as described in more detail with reference to FIGS. 1-3, some or all of the functionality of a cryptography service provider is available on a separate device, namely a mobile station (MS) 30, and the CSP* 26 can call the required functionality from the MS 30.

The mobile station may be exactly as described with reference to FIGS. 1 and 3 above.

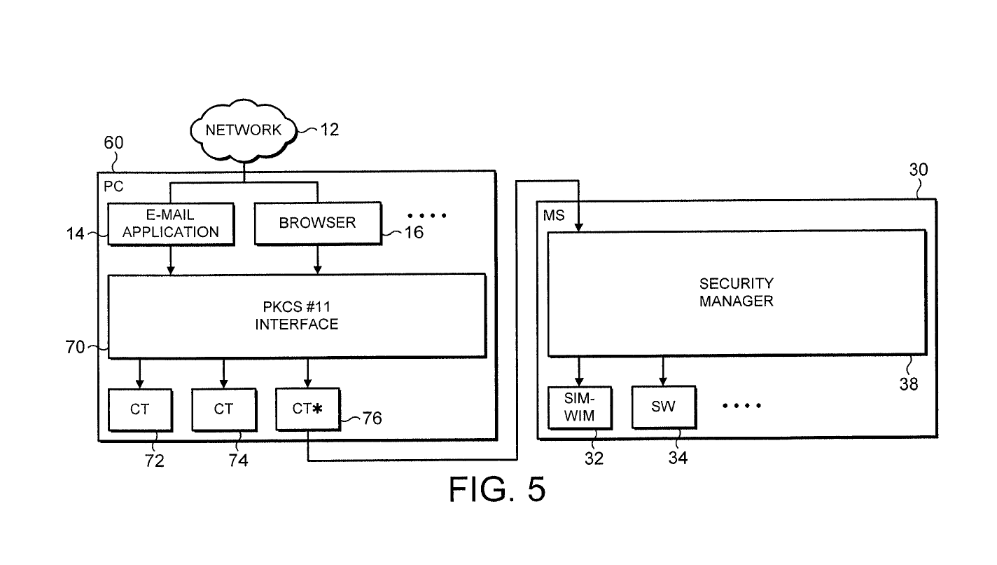

FIG. 5 shows a further alternative system in accordance with the invention.

Again, the computer system is described with reference to a personal computer (PC) 60, but it will be apparent that any computer system can be used in exactly the same way as the PC 60.

The computer has a connection to an external network 12, for example through a modem (not shown) to an unsecured network, such as the internet.

The computer 60 has various software applications which require external communication, such as an email application 14, and a web browser 16, which use Secure Socket Layer (SSL) and/or Transport Layer Security (TLS) security.

As is conventional, applications such as the email application 14 and web browser 16 can call a PKCS#11 interface 70, as an example of a Cryptographic Application Program Interface. The PKCS#11 interface is advantageously as defined in the standards document “PKCS#11 v2.10: Cryptographic Token Interface Standard”, published by RSA Security Inc.

The PKCS#11 interface 70 can access one or more cryptographic tokens (CT) 72, 74.

Different cryptographic tokens (CTs) may, for example, use different cryptographic algorithms, and may be used for different purposes.

In accordance with the present invention, some or all of the functionality of a cryptographic token is available on a separate device, namely a mobile station (MS) 30, as described in more detail below.

The PC therefore includes a modified cryptographic token (CT*) 76 which acts as a cryptography service provider, in that it can call the cryptographic functionality in the mobile phone 30, and may also include some cryptographic functionality.

As in other embodiments of the invention, the mobile station may be any communications device with a suitable cryptographic module, for example a mobile phone, a personal digital assistant (PDA) or a communicator. The mobile station (MS) 30 shown in FIG. 5 is the same as that shown in FIG. 1, and will not be described further.

In order to allow the PC 60 to use the mobile phone 30 as a CSP, there is a communication link between them. As in other embodiments of the invention, the connection may be wired, or wireless. Advantageously, communications between the personal computer 60 and mobile phone 30 can take place using the Bluetooth short-range radio transmission protocol, although an infrared connection is also possible. The protocol for the connection can for example be based on AT commands, and provides security for those communications. The command set is advantageously a version of the command set defined in a standard such as PKCS#11, described in the document “PKCS#11 v2.10: Cryptographic Token Interface Standard”, published by RSA Security Inc. and incorporated herein by reference, where the commands are redefined as AT commands.

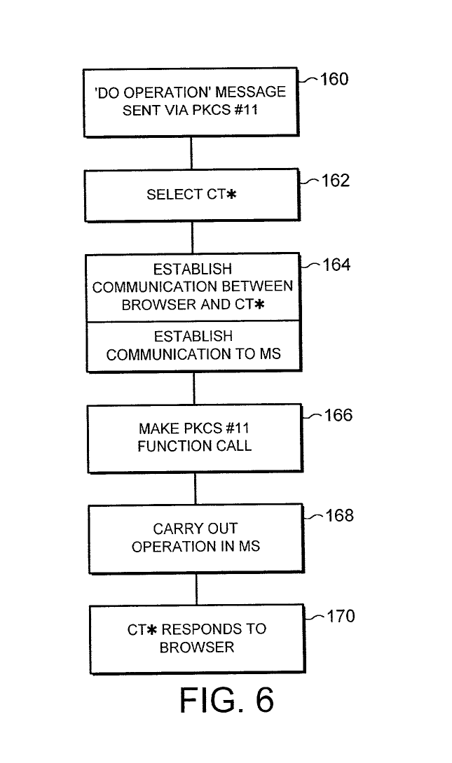

FIG. 6 is a flow chart showing a method by which the PC 60 can use the cryptographic functionality in the mobile phone 30.

The procedure starts with step 160, in which the application in the PC 60, such as the email application 14 or web browser 16 determines that cryptographic functionality is required, and sends a command to the PKCS#11 interface 70. The cryptographic functionality which is required may for example be encryption, decryption, hash generation, message signing, verification, key generation, certificate management or random number generation.

In step 162, the PKCS#11 interface 70 selects an appropriate CT to provide the cryptography function. In this case, the PKCS#11 interface 70 selects the CT* 76, which can access the cryptographic module in the MS 30.

In step 164, the PKCS#11 interface 70 establishes communication between the application and the selected CT* 76, and the CT* 76 establishes communications with the MS 30. As discussed above, the communications between the PC 60 and MS 30 can advantageously be over a Bluetooth short range radio link.

In step 166, a message is passed from the PKCS#11 interface 70 to the MS 30, calling the cryptographic operation which is required.

In step 168, the required operation is carried out in the MS 30, in the same manner as was described with reference to FIG. 3.

In step 170, the result of the operation in the MS 30 is sent to the CT* 26, which then responds to the application which requested the cryptographic functionality.

There are therefore disclosed methods and systems which allow encryption of communications from a computer system, or within a computer system, which can be achieved be reusing functionality which is available in an existing mobile station.

What is claimed is:

1. A method of encrypting communications from a computer having an application program interface, the method comprising using a mobile communications device, which includes a cryptographic module for use in mobile communication, as a cryptographic service provider.

2. A method as claimed in claim 1, wherein the mobile communications device is a WAP-enabled device.

3. A method as claimed in claim 1, wherein the cryptographic module is that used by the mobile communications device for Wireless Transport Layer Security communications.

4. A method as claimed in claim 1, comprising providing a wired connection between the mobile communications device and the computer.

5. A method as claimed in claim 1, comprising providing a wireless connection between the mobile communications device and the computer.

6. A method as claimed in claim 1, comprising:
when the application program interface requires cryptographic functionality, calling a cryptographic service provider function in the mobile communications device.

7. A mobile communications device, comprising a cryptographic module, the cryptographic module being usable:
for encoding wireless communications from the device;
in a cryptographic service provider with an application program interface of a remote computer.

8. A mobile communications device as claimed in claim 7, having a short-range wireless communications transceiver, for sending signals to and receiving signals from the remote computer.

9. A mobile communications device as claimed in claim 7, wherein the short-range wireless communications transceiver uses Bluetooth wireless technology.

10. A mobile communications device as claimed in claim 7, wherein the cryptographic module is usable to support wireless communications using Wireless Transport Layer Security.

11. A mobile communications device as claimed in claim 7, wherein the cryptographic module uses public key cryptography.

12. A mobile communications device as claimed in claim 7, comprising means for sending and transmitting data using WAP.

13. A mobile communications device as claimed in claim 7, wherein the cryptographic module is realized in hardware in the device.

14. A mobile communications device as claimed in claim 7, wherein the cryptographic module is realized in software in the device.

15. A mobile communications device as claimed in claim 7, wherein the cryptographic module is provided on an external smart card.

16. A mobile communications device as claimed in claim 7, wherein the cryptographic module comprises a Wireless Identity Module card.

17. A mobile communications device as claimed in claim 16, wherein the cryptographic module comprises a Wireless Identity Module card which allows communications using Wireless Transport Layer Security.

18. A mobile communications device as claimed in claim 7, comprising an interface for receiving a command from a personal computer, the mobile communications device acting as a cryptographic service provider for said personal computer in response to said command.

19. A module for a personal computer, wherein, in response to the module receiving a first command from a cryptographic application program interface, indicating that it requires cryptographic functionality, the module sends a second command to a mobile communication device, such that the mobile communications device acts as a cryptographic service provider for said personal computer.

20. A method of encrypting computer communications, the method comprising using a separate mobile communications device, which includes a cryptographic module for use in mobile communication, as a cryptographic service provider.

21. A method as claimed in claim 20, wherein the mobile communications device is a WAP-enabled device.

22. A method as claimed in claim 20, wherein the cryptographic module is that used by the mobile communications device for Wireless Transport Layer Security communications.

23. A method as claimed in claim 20, comprising providing a wireless connection between the mobile communications device and the computer.

24. A computer system, comprising:
a computer; and
a mobile communications device, including a cryptographic module,
the computer having at least one application which requires cryptographic functionality,
a first part of the required cryptographic functionality being provided in the computer, and a second part of the required cryptographic functionality being provided in the mobile communications device,
the computer and the mobile communications device having means for establishing a secure communications path therebetween; and
the computer further comprising an interface device which, on determining that an application needs to use cryptographic functionality, selects the functionality provided in the computer, or the functionality provided in the mobile communications device, and sends a command thereto.

25. A computer system as claimed in claim 24, wherein the mobile communications device is a WAP-enabled device.

26. A computer system as claimed in claim 24, wherein the computer application which requires cryptographic functionality is an internal memory access application.

27. A computer system as claimed in claim 24, wherein the computer application which requires cryptographic functionality is an external communication application.

28. A method of providing cryptographic functionality in a computer having a cryptographic application program interface, the method comprising using a mobile communications device, which includes a cryptographic module for use in mobile communication, to provide the cryptographic functionality.

29. A method as claimed in claim 28, wherein the mobile communications device is a WAP-enabled device.

30. A method as claimed in claim 28, wherein the cryptographic module is that used by the mobile communications device for Wireless Transport Layer Security communications.

31. A method as claimed in claim 28, comprising:
when the application program interface requires cryptographic functionality, calling a cryptographic service provider function in the mobile communications device.

32. A method as claimed in claim 28, comprising using a cryptographic module realized in hardware in the mobile communications device.

33. A method as claimed in claim 28, comprising using a cryptographic module realized in software in the mobile communications device.

34. A method as claimed in claim 28, comprising using a cryptographic module provided on an external smart card which can be read by the mobile communications device.

35. A method as claimed in claim 28, comprising using a cryptographic module provided on a Wireless Identity Module card in said mobile communications device.

36. A computer system for supporting an application, the computer system comprising:
a cryptographic application program interface; and
a cryptography service provider,
wherein, when the cryptographic application program interface determines that the application requires cryptographic functionality, sends a command to the cryptography service provider, and
wherein the cryptography service provider has a communications link to a cryptographic module of a mobile communications device, the cryptographic module of the mobile communications device being usable to encrypt communications between the mobile communications device and a telecommunications network over a wireless interface, and
wherein the cryptography service provider can obtain the cryptographic functionality, required by the application, from the cryptographic module of the mobile communications device.

37. A system as claimed in claim 36, wherein the cryptographic module is realized in hardware in the mobile communications device.

38. A system as claimed in claim 36, wherein the cryptographic module is realized in software in the mobile communications device.

39. A system as claimed in claim 36, wherein the cryptographic module is provided on an external smart card which can be read by the mobile communications device.

40. A system as claimed in claim 36, wherein the cryptographic module is provided on a Wireless Identity Module card in said mobile communications device.

41. A system as claimed in claim 36, wherein the cryptography service provider has a Bluetooth wireless communications link to the mobile communications device.

42. A system as claimed in claim 36, wherein the cryptography service provider has some cryptographic functionality, and, on receipt of a command from the cryptographic application program interface, determines whether it can perform the required cryptographic functionality, or whether to obtain the required cryptographic functionality from the cryptographic module of the mobile communications device.

43. A system as claimed in claim 36, wherein the communications link between the cryptography service provider and the cryptographic module of the mobile communications device uses a command set defined in a standard PKCS#11, where the commands are redefined as AT commands.

44. A mobile communications device, the mobile communications device being able to communicate over a first wireless interface with a telecommunications network, and comprising a cryptographic module to provide cryptographic functionality for use in communications over the first wireless interface, the mobile communications device further comprising a security manager module for receiving commands from a computer system over a second interface, wherein, in response to suitable commands received from the computer system over the second interface, the security manager module requests a cryptographic function from the cryptographic module, and returns the results of the cryptographic function to the computer system over the second interface.

45. A mobile communications device as claimed in claim 44, wherein the security manager module responds to a command set defined in a standard PKCS#11, where the commands are redefined as AT commands.

46. A mobile communications device as claimed in claim 44, wherein the second interface is a Bluetooth short-range radio interface.

47. A module for a computer system, the module comprising:
an application interface for connection to a computer application; and
an external interface for connection to a mobile communication device containing a cryptographic module;
wherein, when the module receives from the application interface a request for a cryptographic function which the module is unable to provide, the module sends a command over the external interface to the mobile communications device to request the cryptographic function therefrom.

48. A module for a computer system as claimed in claim 47, wherein the module has some cryptographic functionality, and comprises means for determining in response to a request from the application interface whether it is able to provide the requested function cryptographic function.

49. A module for a computer system as claimed in claim 47, wherein the external interface is a Bluetooth short-range radio interface.

50. A module for a computer system as claimed in claim 47, wherein the module sends over the external interface a command from a command set as defined in a standard PKCS#11, where the commands are redefined as AT commands.
